(19) United States
(12) Patent Application Publication
(10) Pub. No.: US 2019/0095544 A1
(43) Pub. Date: Mar. 28, 2019

(54) BEHAVIORAL SIGNALS FOR AUTOMATED CONTENT QUALITY EVALUATION IN A SOCIAL NETWORK

(71) Applicant: Facebook, Inc., Menlo Park, CA (US)

(72) Inventors: Bogdan State, La Honda, CA (US); Lada Ariana Adamic, Mountain View, CA (US); Carlos Gomez Uribe, Campbell, CA (US)

(21) Appl. No.: 15/719,236

(22) Filed: Sep. 28, 2017

(51) Int. Cl. G06F 17/30; G06Q 50/00

(52) U.S. Cl. CPC G06F 17/30979; G06Q 50/01

(57) ABSTRACT

Methods, systems, computer-readable media, and apparatuses for using, by one or more computer devices, engagement actions by users of a social network as behavioral signals for evaluating the quality of a content item shared by those users. Once the quality of a content item has been evaluated in this manner, an action can be performed on that content item (e.g., changing the visibility of that content item within the social network).

### BACKGROUND

Aspects of the disclosure relate to techniques for automatically evaluating the quality of shared content items in a social network. Social networks can be platforms that facilitate social interactions between users of the social network (e.g., messaging, posting links to articles or images, participating in groups, etc.). Social networks are increasingly becoming integrated with modem society as a means for users to interact with and keep in touch with other users of the social network. Many users utilize social networks as means to express their emotions and/or intentions, as well as to share content items with other users.

Social networks may allow users to view content items that have been shared with them. In some cases, the social network may have a feed that provides user curated content items that have been shared with that user. However, the user may not always desire to view all of the curated content (e.g., some of the content may be of low quality and of little interest to the user). Therefore, for the purposes of active user engagement, it may be important for the feed to provide mainly high quality content that a user wishes to view and keep that high quality content visible within the feed. This maintains a high signal-to-noise ratio for displayed content and provides substantial value to the user, which will keep the user returning to the social network.

There are numerous ways, both manual and automatic, through which the quality of content items may be evaluated. For example, a team of professional reviewers could be hired to manually evaluate and label each shared content item. However, this approach may be quite labor intensive and time consuming. Alternatively, machine learning models can be developed to evaluate, classify, and label shared content items. However, machine learning models can only be used to accurately evaluate content items similar to the ones used to train those models and are not very useful for evaluating content items of low quality for reasons that were previously unknown.

Accordingly, a need exists for improved techniques to evaluate the quality of shared content items on social networks.

### BRIEF SUMMARY

Techniques of the disclosure can be used to automatically evaluate the quality of a shared content item in a social network based on behavioral signals associated with the users that have shared that particular content item.

One such behavioral signal is the share frequency of each user, which can be used as a proxy for gauging average quality of content shared by the user. In particular, if users who share frequently are sharing content of lower quality (e.g., the user is prioritizing quantity over quality and not heavily scrutinizing the content being shared), then the share frequency of a user may be inversely proportional to the average quality of that user's shared content items. The user's share frequency over a period of time can be used to calculate a score or rating for the user that is associated with how likely that user shares content (e.g., the user's ‘trigger happiness’ for sharing).

For each unique content item that is shared in the social network, the scores for all the users that have shared that particular content item can be used as a signal of that content item's quality. For example, if a particular content item has been shared mostly by users who are extremely ‘trigger happy’ for sharing (e.g., shared by users with high share frequency over the measured period of time), then that particular piece of content may likely be of lower quality. Content items that are determined to be of low quality in this manner can have their visibility adjusted within the social network. For example, low quality content items can be demoted so that they are not presented at the top of user feeds where they are most likely to catch a user's attention. This maintains the visibility of high quality content items and improves the overall experience of the social network and the engagement of users within the social network.

Other behavioral signals besides user share frequency may also be used for evaluating shared content items. Examples of other behavioral signals include the engagement frequency of each user, which can be based on various types of a user's engagement with the social network. For instance, a user's engagement frequency may be based on engagement such as sharing, clicking, liking, commenting, and so forth. A user's engagement frequency could also be based off of how much that user liked other user's shared content, how much the user commented on the social network, how frequently the user shared or re-shared content, how much time the user spent reading content shared with them (e.g. this user barely looks at the content that they are re- sharing), and so forth.

However, it should be noted that for the purposes of facilitating ease of understanding, this disclosure primarily uses the example of evaluating content item quality based on user share frequency as a behavioral signal. This is not intended to be limiting. Any behavioral signal, such as a user's engagement frequency based on any type of engagement, can be used to evaluate content item quality. Accordingly, any discussion regarding user sharing and user sharing frequency may be applicable to any other type of user engagement.

In various embodiments of the present disclosure, methods, systems, and instructions are contemplated that involve one or more internetworked computer devices implementing a social network. For instance, one exemplary method may involve using the one or more internetworked computer devices to identify a set of engagement actions relating to each user of a first plurality of users on the social network. The set of engagement actions relating to each user of the first plurality of users is associated with the respective user engaging content items on the social network (e.g., sharing, re- sharing, commenting, liking, and so forth).

The method may further include determining, by the one or more internetworked computer devices, a user engagement score for each user of the first plurality of users based on the set of engagement actions relating to the respective user. The one or more internetworked computer devices may identify a second plurality of users on the social network that has engaged a content item on the social network, with the second plurality of users being a subset of the first plurality of users. The method may further include retrieving, by the one or more internetworked computer devices, the user engagement score for each user of the second plurality of users. The one or more internetworked computer devices may determine a content quality score for the content item based on the retrieved user engagement score for each user of the second plurality of users. Based at least in part on the content quality score, the one or more internetwork computer devices may perform an action for changing visibility of the content item within the social network.

In some embodiments, the set of engagement actions relating to each user of the first plurality of users includes new shares or re-shares by the respective user of the first plurality of users. In some embodiments, the set of engagement actions relating to each user of the first plurality of users includes new shares or re-shares over an eight day time period by the respective user of the first plurality of users.

In some embodiments, the method includes determining, by the one or more internetworked computer devices, a user engagement score formula. Determining the user engagement score for each user of the first plurality of users may further be based on this user engagement score formula. In some embodiments, the method includes determining, by the one or more internetworked computer devices, a content quality score formula. Determining the content quality score for the content item may further be based on the content quality score formula.

In some embodiments, the content item is a website, webpage, image, or video clip. In some embodiments, the set of engagement actions relating to each user of the first plurality of users includes likes, comments, or clicks initiated by the respective user of the first plurality of users. In some embodiments, the user engagement score formula is 1/[1+log 2(1+R)], with R being a ratio of new shares or re-shares per day over an eight day time period by the respective user of the first plurality of users. In some embodiments, the one or more internetworked computer devices are configured to store a plurality of records for each user of the first plurality of users. The plurality of records for the respective user includes the set of engagement actions relating to the respective user, and each record of the of the plurality of records for the respective user logs an engagement action with associated with the content item.

In some embodiments, the content quality score is indicative of low quality and the action performed for changing visibility of the content item within the social network includes removing the content item from a user feed. In some embodiments, the content quality score is indicative of low quality and the action performed for changing visibility of the content item within the social network includes preventing the content item from appearing in a user feed. In some embodiments, the user engagement score for each user of the first plurality of users is a value between zero and one. In some embodiments, the content quality score for the content item is an average of the retrieved user engagement score for each user of the second plurality of users.

### BRIEF DESCRIPTION OF THE DRAWINGS

Aspects of the disclosure are illustrated by way of example. In the accompanying figures, like reference numbers indicate similar elements.

FIG. 1 illustrates a simplified diagram of a social network infrastructure that may include features of the disclosure;

FIG. 2 illustrates a simplified diagram of a social network that may be implemented with the social network infrastructure of FIG. 1;

FIG. 3 illustrates a simplified diagram of a social network including a user engagement scorer that may include features of the disclosure;

FIG. 4 illustrates a user engagement scorer that may include features of the disclosure;

FIG. 5 illustrates an example flowchart to implement features of the disclosure regarding calculating a user engagement score associated with a user's sharing activity for a specified time period;

FIG. 6 illustrates an example flowchart to implement features of the disclosure regarding calculating a content quality score associated with a particular content item that has been shared by users of the social network.

FIG. 7 illustrates an example of a computing system in which one or more embodiments may be implemented; and

FIG. 8 illustrates an example environment in which one or more embodiments may be implemented;

### DETAILED DESCRIPTION

Introduction

Social networks may allow users to view content items that have been shared with them. These content items may include websites or webpages (e.g., URLs or links), articles, images, photos, video clips, audio clips, and so forth. In some embodiments, the social network may have a feed that provides user curated content items that have been shared with that user. However, it may be undesirable for shared content of low quality to populate a user's feed or to be ranked highly in the feed (e.g., such that the content is more visible to the user). Low quality content items may be of little interest, or even off- putting, to the user which can affect the user's engagement with the social network.

Low quality content may be defined as content that falls under certain labels or classifications (e.g., the content fits pre-defined parameters known to be associated with low quality) or content that would be holistically viewed as low quality (e.g., the content does not fall under clear pre-defined parameters but meets the “I know it when I see it” threshold test, such that the content would be subjectively classified under low quality by the average user within the web community).

Examples of low quality content that fall under the latter definition (e.g., content that does not fall under clear pre-defined parameters) may include a certain class of low-quality content that may engender different reactions from different sets of users (termed “unsparing” content for the purposes of this disclosure). Unsparing content may be defined as content that different groups of users have strong, but different, reactions to. For instance, a first group of users may have a strong desire to view and/or share a particular piece of unsparing content (and also any related content), while a second group of users may prefer to not view and/or share that particular piece of unsparing content (or any related content). Although the underlying topic associated with the unsparing content may not necessarily be problematic for a web community or social network, the issue with unsparing content may be that it receives disproportionate visibility because it naturally attracts and furthers the agenda of a particular group of users, leading to oversharing of the unsparing content. This results in other content, potentially even other content on the same topic, not receiving the same amount of sharing and distribution. In effect, unsparing content can be an obstruction to completely free sharing by clogging up and dominating the feed. For users who have no desire to view the unsparing content, they may become less engaged with the social network if their feed is primarily populated by the unsparing content.

In some cases, the unsparing content item may overlap with objective labels associated with low quality content (e.g., the unsparing content item falls under the first definition of low quality content because it fits pre-defined parameters known to be associated with low quality). For instance, unsparing content may often be correlated with other kinds of low quality content, such as low quality content associated with ad- farms or withholding. However, in many cases, the unsparing content item may escape classification under any existing labels associated with low quality content (e.g., the unsparing content does not fit pre-defined parameters known to be associated with low quality).

Machine learning models can be trained to label and classify low quality content items that fall under the first category (e.g., content that fits pre-defined parameters, labels, or classifications). However, those models are typically most useful for evaluating content items similar to the ones used to train those models and are not very useful for evaluating content items that deviate from the training set. As a result, those models may not be able to identify low quality content of the second category (e.g., content that does not fit pre-defined parameters but would be holistically viewed as low quality), including unsparing content that escapes classification.

As an alternative, techniques of the disclosure are directed towards evaluating the quality of a shared content item in a social network based on behavioral signals associated with the users that have shared that particular content item. One such behavioral signal is the share frequency of each user. In particular, the share frequency of a user can be used to gauge the average quality of content shared by the user. However, the relationship between a user's share frequency and the user's average shared content quality may depend the behavioral tendencies of the population of users.

For instance, one possibility may be that users who share frequently are sharing content of higher quality because those users are spending a lot of time actively sharing content. Another possibility may be that users who share frequently are sharing content of lower quality (e.g., the user is prioritizing quantity over quality and not heavily scrutinizing the content being shared). If the latter case is true, then the share frequency of a user can be used as a inversely proportional signal of that user's average shared content quality. In some embodiments, the share frequency of a user over a period of time can be further used to define a score or rating (e.g., a user engagement score or a user sharing score) over that period of time that is associated with how likely that user shares content (e.g., the user's ‘trigger happiness’ for sharing).

Furthermore, the score (e.g., based on the sharing tendencies) of all the users that have shared a particular piece of content can be used as a signal of that content's quality. For example, if a particular piece of content has been shared by users who have shared hundreds of pieces of content within a week (e.g., shared by users with extremely high sharing frequency), then that particular piece of content is likely to be of lower quality. Accordingly, the score of all the users that have shared a particular piece of content can be further used to define a score (e.g., content quality score) associated with that particular piece of content. In other words, content item quality can be evaluated based on per-user probabilities of sharing any class of content, with the probabilities aggregated at the content level (e.g., across all the users sharing that content item) in order to evaluate the quality of the content item.

Thus, instead of applying machine learning models to identify and label content of low quality, content items can be evaluated based on these behavioral signals and the resulting content quality score. In practice, the identification of low quality content items through behavioral signals may be very effective. In fact, overshared content with low content quality score (and shared mostly by users who frequently share) may often overlap or highly correlate with content labeled as low quality by professional reviewers or machine learning models, in addition to encapsulating content that is unsparing or otherwise problematic and escapes classification under one of the pre-defined parameters.

The ability to determine a content quality score and evaluate the quality of any content item being shared in the social network can enable numerous actions that can be taken to improve the overall experience for users of the social network. For instance, since the identification of low quality content items through behavioral signals can be used to identify unsparing content that would otherwise escape identification, any unsparing content can be restrained and prevented from dominating user feeds. In particular, the content quality score for a content item can used to rank that content item in a feed that is presented to a user. In other words, if a content item has a low content quality score, the content item can be demoted within the feed so that it is not presented at the top of the feed (e.g., where it is most likely to catch the user's attention).

As another example, the activities of users with low content engagement score (e.g., users that frequently share) can be quarantined from affecting the ranking calculations for content in the feed. In probabilistic ranking models, the ranking of a particular piece of content within the feed may be directly related to the probability that the content is shared (e.g., under the assumption that higher quality content is more likely to be shared by users). However, these probabilistic ranking models may be misled by low quality content being shared at a high rate by users with high sharing frequency. In other words, the users with high sharing frequency may be ‘boosting’ the ranking of that particular piece of content within the feed. To counteract this, the content ranking can be determined without considering the sharing of users with high sharing frequency. Furthermore, the effect of shares from users with high sharing frequency can be ignored when training the models traditionally used to classify content quality.

Thus, the accurate evaluation of content item quality using behavioral signals can be used to reduce user exposure to content items of low quality and of little interest to the user. By consistently providing high quality content items to the user and maintaining a high signal-to-noise ratio for displayed content, substantial value is provided to the user and active user engagement with the social network is promoted.

Figures

Several illustrative embodiments will now be described with respect to the accompanying drawings, which form a part hereof While particular embodiments, in which one or more aspects of the disclosure may be implemented, are described below, other embodiments may be used and various modifications may be made without departing from the scope of the disclosure or the spirit of the appended claims.

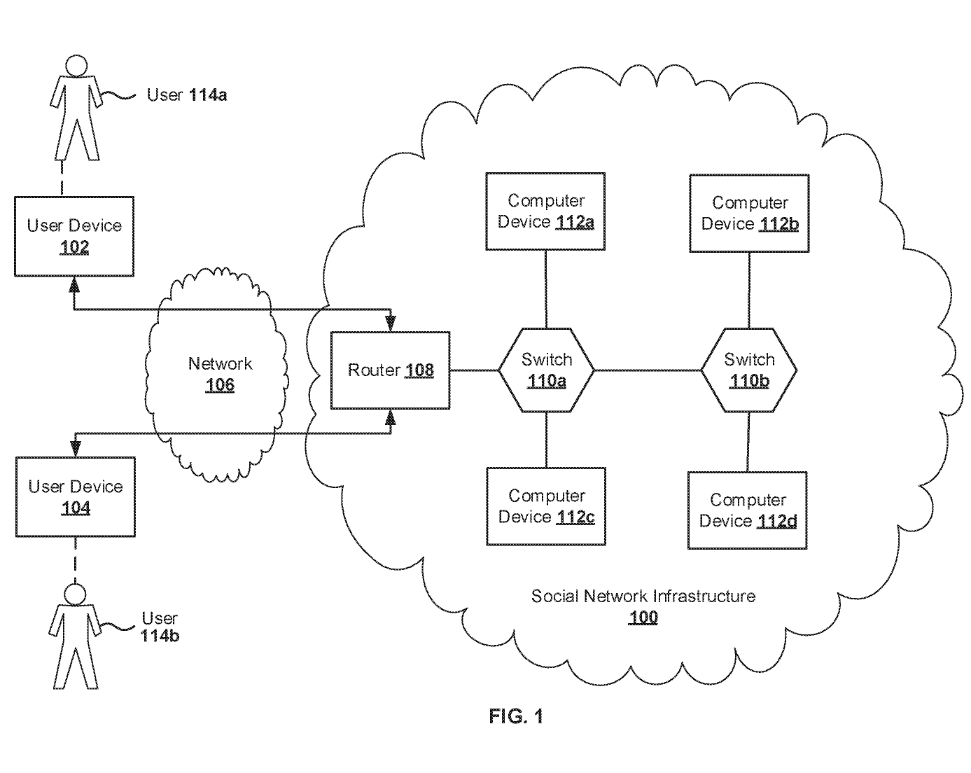

FIG. 1 illustrates a simplified diagram of a social network infrastructure 100 and users 114a-114b that may interact with functionality provided by computer device(s) 112a-112d within the social network infrastructure 100. User 114a may be associated with a corresponding user device 102. User device 102 can be, for example, a computer, a smartphone, a tablet, a smart watch, etc. Similarly, user 114b can be associated with a corresponding user device 104. Each of user devices 102 and 104 can communicate with device(s) of social network infrastructure 100 via network 106. Network 106 can represent, for example, the internet. Network 106 can include various switches or similar devices to facilitate movement of data between user devices 102 and 104 and social network infrastructure 100.

Social network infrastructure 100 can include an edge router 108 that can be used as a gatekeeper (domain separator) between social network infrastructure 100 and external computer device(s) or computer network(s). Although only one router 108 is illustrated, it should be understood that social network infrastructure 100 can include a plurality of routers. Furthermore, social network infrastructure 100 can be distributed across various geographical locations or domain(s) within a computer network (such as the internet). Social network infrastructure 100 can also include a plurality of computer devices 112a-112d that can each be a computer server, access terminal, etc. Switches 110a-110b can be used to forward network packet to or from router 108 and one or more of computer devices 112a-112d to facilitate functionality of a social network.

User 114a may interact, via user device 102, with social network infrastructure 100 to facilitate performing an action to a corresponding social network (such as posting a content item to the social network, providing profile information to the social network, etc.). User 114b may also interact with user 114a via the social network. For example, user 114b may reply, via user device 104 to a content item posted by user 114a. Thus, users 114a-b may perform actions to a social network implemented by social network infrastructure 100 by interacting with respective user devices 102 and 104 coupled to social network infrastructure 100.

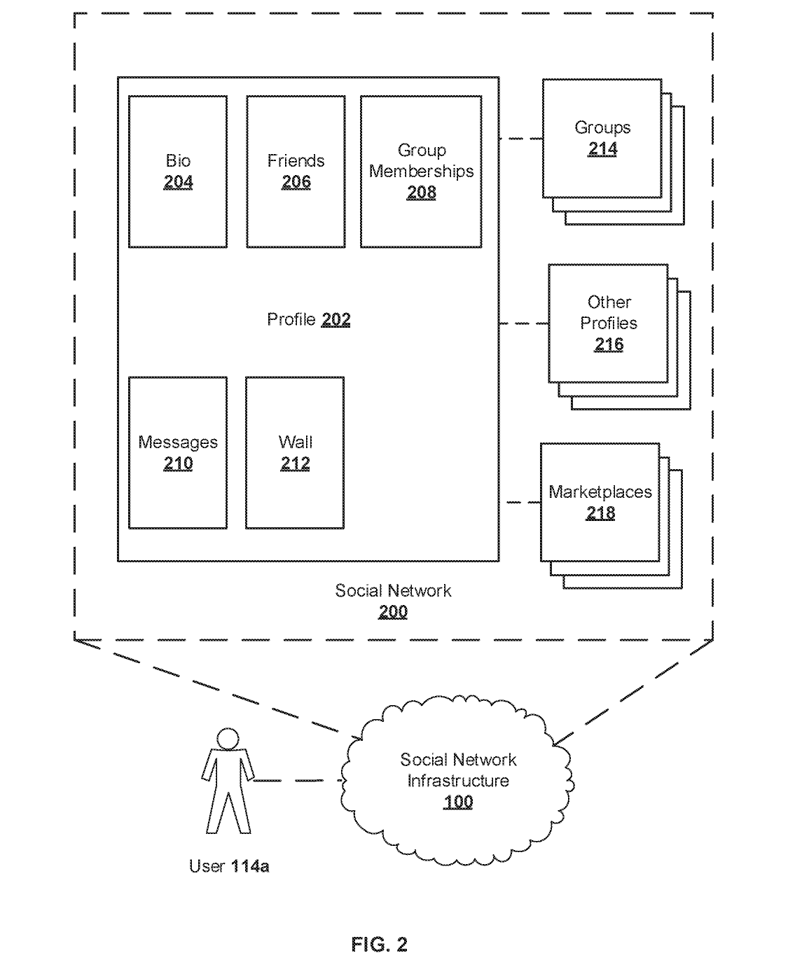

FIG. 2 illustrates a simplified diagram of a social network 200 that can be implemented by social network infrastructure 100. Social network 200 can include, among other things, a plurality of user profiles each corresponding to a user of social network 200. Profile 202 can correspond to user 114a, for example. Other profiles 216 are illustrated that can each correspond to a respective other user of social network 200. User 114a can interact with social network 200 in a variety of manners including performing actions on social network 200.

Actions on social network 200 can include changing an aspect of a profile, messaging another users, changing user setting(s), changing a profile's associations within social network 200, any combination of the preceding, or other. For example, user 114a may perform an action on social network 200 by updating their profile 202. An action may include updating biographical information 204 contained within the profile 202, such as updating a profile picture, changing favorite quotes, changing movie or music preferences, changing “likes,” etc. An action may also include changing friend relationships 206 between profile 202 and other profiles 206, for example. User 114a may be associated with other profiles 216 through friendship or other associations/links present within social network 200. The associations can include voluntary sharing of information between the profiles, access to certain information of a profile, etc. Similarly, group membership associations/links 208 can be modified via an action performed by user 114a. For example, user 114a may modify which groups 214 they are a part of. Groups 214 may be logically associated profiles of users that share common interests or communicate with each other via a group.

An action may also include posting a content item via a message 210 or wall 212, for example. Message 210 can be a direct, point-to-point communication between user 114a and another user of social network 200. Wall 212 can be a shared posting area wherein multiple users of social network 200 are privileged to read and/or modify (via posting of a content item, for example) the posting area. An action to social network 200 may include an action directed to another user's profile such as a profile of other profiles 216. User 114a may, for example, post a content item to a group 214, a wall of another user's profile 216, and/or to a marketplace 218. Marketplaces 218 may be areas within social network 200 wherein users may post items or services for sale or communicate a desire to purchase an item or service.

Certain users of social network 200 may not have an associated profile. For example, certain users may access a profile of a user of social network 200 without themselves having a profile. They may access a content item posted by another user on a wall, within a group, within a marketplace, etc. Such a user may be considered a guest user and may have limited privileges within social network 200. Furthermore, data associated with a guest user may be relatively limited as compared to a user having an associated profile within social network 200.

Data can be created within social network 200 in response to actions by users within social network 200. In particular, a content item posted within the social network 200 may be evaluated for quality and its visibility within the social network 200 may be adjusted based on that evaluation. For example, user 114a may perform an action of posting a content item to wall 212. This posted content item may be visible to other users via a feed (not shown) viewable to each of those users, who may in turn respond or comment to the posted content item. The visibility of the posted content item (e.g., the location within the feed at which the content item is displayed) may be adjusted based on the evaluated quality of the content item, which will affect how likely the other users will see that content item and respond/comment to it.

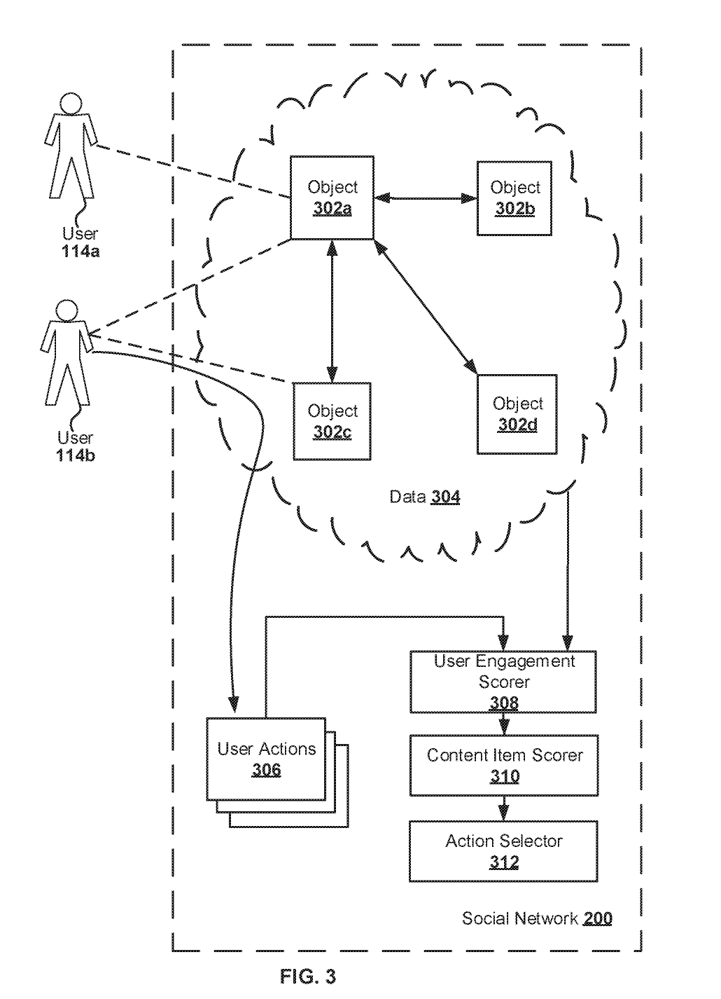

FIG. 3 illustrates social network 200 and objects 302a-302d which each may be modified via action(s) performed user 114a or user 114b. Objects 302a-302d can represent groups, walls, messages, marketplaces, etc., such as those illustrated in FIG. 2. As one example, user 114a may post a content item to object 302a and user 114b may post a responding content item to object 302a. Furthermore, User 114a may post to object 302b and another user (not illustrated) may post a response in object 302b. User 114b may also post a content item to object 302c regarding user 114a which may form part of data 304. As users interact with objects 302a-302d, they may generate data 304 within social network 200.

The data 304 can be used to evaluate behavioral signals associated with the user(s), which may then be used to evaluate the quality of content items shared by the user(s). For example, user 114a may be interact with (e.g., modify) social network 200 while other users (such as user 114b) respond to the interactions. These interactions (e.g., the sharing and re-sharing of content items) can collectively form data 304. Data 304 may also include metadata (e.g., background data within social network 200 that may be associated to a user or user action but may not be directly assessable by a user).

User Engagement Scorer 308 is illustrated as a module of social network 200. User Engagement Scorer 308 can be implemented by one or more of computer devices 112a-112d and can be configured to evaluate behavioral signals (e.g., sharing) associated with a user in order to determine a user engagement score or a user sharing score associated with the user.

As illustrated, real-time user actions 306 (e.g., actions associated with user 114b) may be provided to User Engagement Scorer 308 along with historical user actions (e.g., recorded within data 304). The User Engagement Scorer 308 may be configured to identify a certain set or combination of actions associated with user engagement over a period of time. For example, the User Engagement Scorer 308 may be configured to identify all shares or re-shares of content performed by user 114b over a certain period of time. The User Engagement Scorer 308 may monitor and identify sharing activity by user 114b in real-time from the user actions 306, as well as identify historical sharing activity for user 114b over that period of time within data 304.

In some embodiments, the User Engagement Scorer 308 may be configured to apply a formula to the identified actions associated with the user's engagement over the period of time in order to calculate a user engagement score (e.g., a user sharing score) for the user. The User Engagement Scorer 308 may further be configured to keep the user engagement score current by updating it as the user continues to engage with the social network 200 (e.g., by monitoring the engagement activity from the user within the user actions 306).

In some embodiments, the User Engagement Scorer 308 may monitor a user's per-day sharing rate. For example, a user's total amount of shares may be divided by the total number of days the user's account has been active. In some embodiments, a user's per-day sharing rate over a limited period of time (e.g., 8 days) may be used. For example, a user's share rate (e.g., new shares and re-shares) over the past 8 days may be used. Thus, users with high sharing frequency can be identified by monitoring just how frequently that user shares content over a given period of time. For example, a user that shares, on average, 25 times in a period of a week objectively has a higher sharing rate than a user that shares, on average, 5 times in a period of a week.

In some embodiments, the User Engagement Scorer 308 may calculate a user engagement score from each user's sharing rate. In some embodiments, the formula used may be 1/[1+log 2(1+R)], where R is the user's daily share rate (e.g., new shares and re-shares) over the past 8 days. For example, a user may have linked to 16 articles without re-sharing over the past 8 days. Thus, R, or the user's daily share rate, would be 2 shares per day. The user's score would then be 1/[1+log 2(1+2)], which is approximately 0.387. For comparison, a second user may have linked to 80 articles without re-sharing over the past 8 days. The second user's daily share rate would be 10 shares per day. The second user's score would then be 1/[1+log 2(1+10)], which is approximately 0.224. Thus, the second user's score is lower, which is reflective of the user sharing much more frequently. If the first and second user both shared a particular content item, the evaluation of that content item's quality would include both scores for the first and second user (and the scores of any other users that shared the content item). The content item's perceived quality may be lowered by nature of the second user having a lower score due to higher sharing frequency.

In some embodiments, Content Item Scorer 310 may be a module of social network 200 that is configured to evaluate the quality of shared content items (e.g., within data 304) based on the scores associated with each user that has shared the content item. For each content item, the Content Item Scorer 310 may be configured to determine all of the users that have shared that content item and retrieve the user engagement scores (e.g., determined by the User Engagement Scorer 308) for all the users that have shared that content item. In some embodiments, the Content Item Scorer 310 may be configured to apply a formula to the user engagement scores for all the users that have shared that content item in order to calculate a content quality score for the content item. The Content Item Scorer 310 may further be configured to keep the content quality score for the content item current by updating it as new users (more specifically, users that have not previously shared that content item) share the content item.

In some embodiments, the content item may be a ‘page’ on the social network, which can contain sub-content (e.g., many URLs linked in the page). In such embodiments, the Content Item Scorer 310 may further generate a content quality score for the page that factors in the content quality score of all the sub-content (e.g., the URL-level score for all the URLs shared in the page). In some embodiments, the content quality score for the page may be dependent on the distribution of the URL-level scores. Thus, content quality scores may be available for sub-content (e.g., the URL-level) and for content items (e.g., ‘pages’) containing the sub-content. In effect, the content quality scores for the pages will be an average of the URL-level content quality scores, which themselves can be averages of user engagement scores.

In some embodiments, separate counters for content quality scores may exist for each unique content item that keeps a ‘running average’ of that content item's content quality score. When a new user shares the content item, that user's engagement score may be incrementally factored into the existing content quality score in order to update the content quality score (rather than having to calculate the entire content quality score from scratch by retrieving the user engagement scores of all the users that have shared that content item).

Action selector 312 can then select and/or implement an appropriate action to take with the content item based on the content quality score. For example, action selector 312 may reduce the visibility of a content item within the social network 200 if it has a low content quality score.

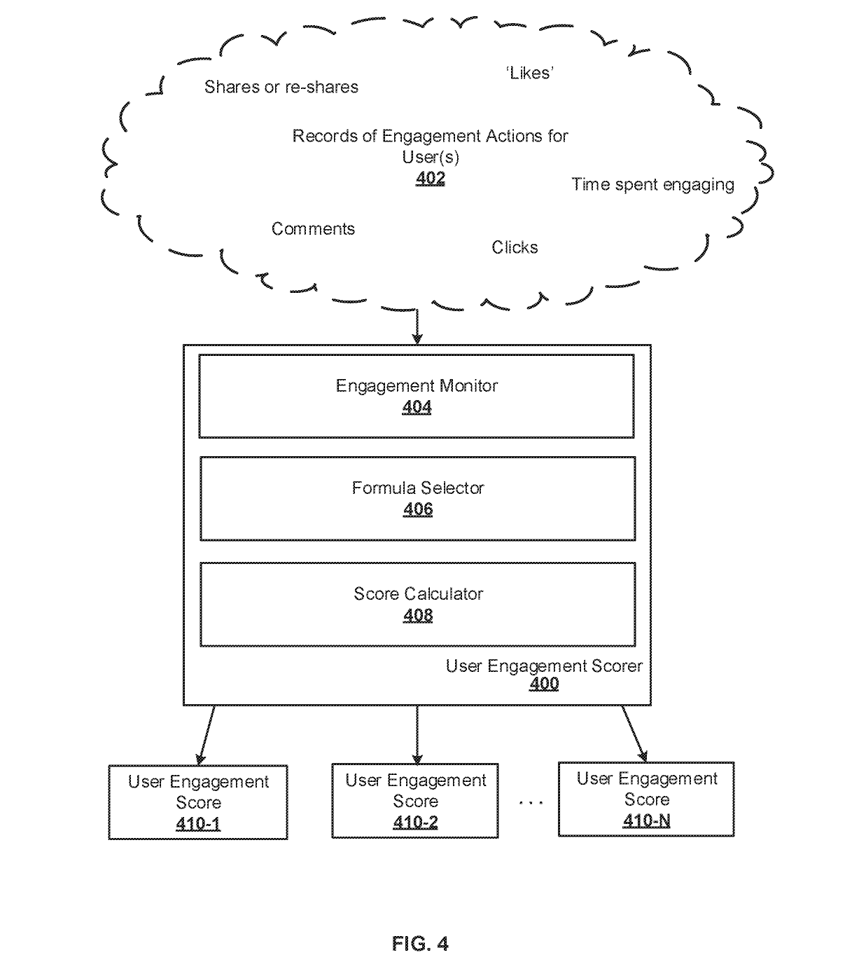

FIG. 4 illustrates a logical view of an User Engagement Scorer 400 that can be similar to User Engagement Scorer 308. The User Engagement Scorer 400 can receive records of engagement actions associated with user(s) 402, which can be included within data 304 or user actions 306, for example. The records 402 may include engagement actions such as user shares or re-shares of content items, user ‘likes’ of shared content items, user comments (e.g., on shared content items), user clicks (e.g., clicking on shared links to webpages), and time spent engaging (e.g., time spent by the user reading shared content items).

The User Engagement Scorer 400 may include an Engagement Monitor 404, a Formula Selector 406, and/or a Score Calculator 408. The Engagement Monitor 404 may monitor the engagement actions for each user and determine/retrieve the relevant engagement actions made by the user over a period of time. The relevant engagement actions may depend on the formula being applied by the User Engagement Scorer 400. For instance, the User Engagement Scorer 400 may be configured to determine user sharing frequency, which would make the relevant engagement actions the shares or re-shares performed by each user.

The Formula Selector 406 may select the formula to apply for each user's engagement actions. In some embodiments, the formula may be based on an evaluation of the typical quality of content items shared by the user. For example, the quality (e.g., based on the content quality score) of all the content shared by the user can be averaged. Or alternatively, the formula may consider the percentage of content shared by the user that has been classified under an undesirable category (e.g., by a machine learning model).

The Score Calculator 408 may then calculate a user engagement score for each user based on the formula to be applied to that user. As a result, a user engagement score is generated for each user of the social network, including User Engagement Score 410-1, User Engagement Score 410-2, all the way up to User Engagement Score 410-N.

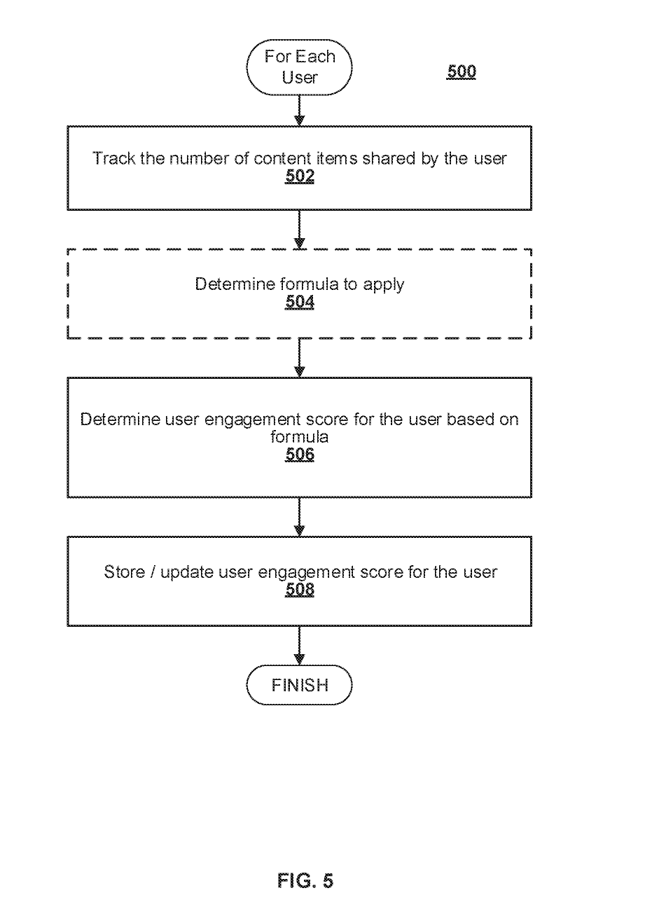

FIG. 5 illustrates a flowchart 500 depicting a process for calculating a user engagement score associated with a user's sharing activity for a specified time period.

At block 502, for a specific user, the system may track the content items shared and re-shared by the user. This may be an on-going process, where the system keeps records of the user's past sharing activity (e.g., in records, logs, databases, and so forth) while also monitoring any new sharing activity of the user (e.g., for any new shares or re-shares). In some embodiments, the record of a user's share may include the content item shared or an identifier of the content item shared (e.g., a content ID, a URL, and unique hash generated from the content item, and so forth), a timestamp associated with the sharing activity (e.g., a time and date), and an identifier of the user (e.g., a user ID). In some embodiments, the system may maintain records of a user's sharing activity over the duration of a user's account. In some embodiments, the system may maintain records of a user's sharing activity over the duration a time period associated with the user engagement score formula. For example, if the user engagement score formula utilizes a user's daily share rate over a 8 day window, then the system may maintain records of a user's sharing activity over that 8 day window.

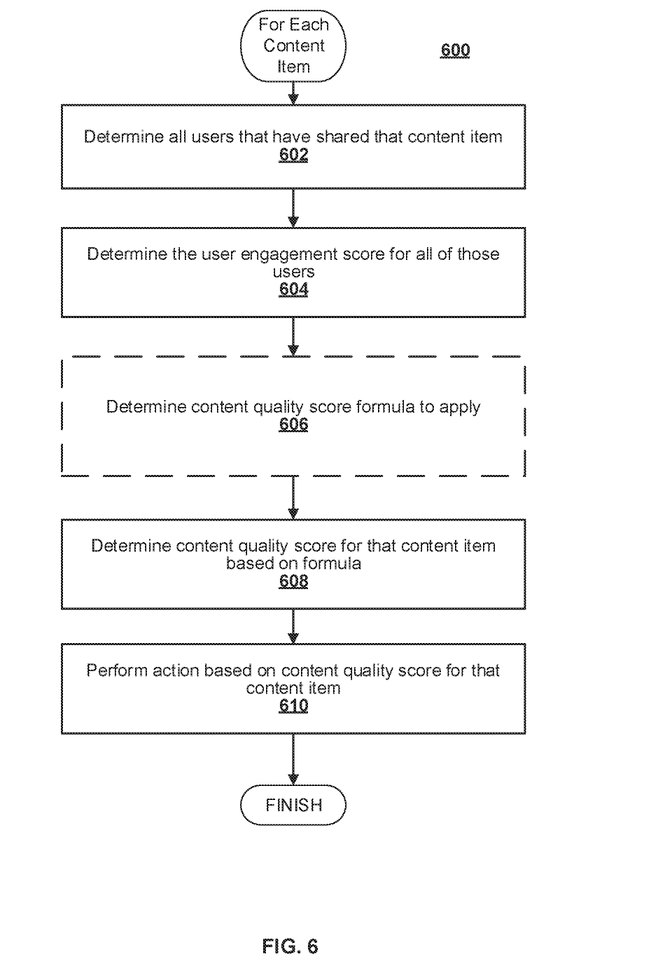

At block 504, the system may optionally determine a user engagement score formula to apply to generate an aggregate score based on a user's sharing frequency. Any model used to evaluate the quality of a content item (e.g., through a process similar to the one depicted in FIG. 6) may utilize this user engagement score associated with each user instead of directly using each user's per-day sharing volume).

As previously mentioned, in some embodiments, the formula used to generate a user's engagement score may be 1/[1+log 2(1+R)], where R is the user's daily share rate (e.g., new shares and re-shares) over the past 8 days. In particular, this formula may be used to provide normalized scores between 0 and 1 while also reducing the effect of outlier users with very high daily share rates. Due to the nature of the loge function, users with very high R values (e.g., corresponding to very high user daily share rate) do not receive outlier scores that will skew the results when the scores of all users are considered (e.g., if all the user scores are averaged). For example, a user that links to 800 articles without re-sharing over the past 8 days would have a daily share rate of 100 shares per day. That user's score would be 1/[1+log 2(1+100)], which is approximately 0.131. That user's score is lower than the score of someone sharing about 10 shares per day (e.g., 0.224), but not so much lower that it dwarfs the significance of the score of the 10 share-per-day user.

For example, a user may have linked to 16 articles without re-sharing over the past 8 days. Thus, R, or the user's daily share rate, would be 2 shares per day. The user's score would then be 1/[1+log 2(1+2)], which is approximately 0.387. For comparison, a second user may have linked to 80 articles without re-sharing over the past 8 days. The second user's daily share rate would be 10 shares per day. The second user's score would then be 1/[1+log 2(1+10)], which is approximately 0.224. Thus, the second user's score is lower, which is reflective of the user sharing much more frequently. If the first and second user both shared a particular content item, the evaluation of that content item's quality would include both scores for the first and second user (and the scores of any other users that shared the content item). The content item's perceived quality may be lowered by nature of the second user having a lower score due to higher sharing frequency.

Other formulas may be used for each user's engagement score in order to achieve various objectives. For instance, formulas may be selected that normalize scores within a certain range or do not normalize scores. Formulas may be selected that remove or downplay outliers (e.g., users with very high daily share rates). Formulas may be selected that provide added focus on outliers. Formulas may be selected that are linear functions of a user's daily share rate, exponential functions of a user's daily share rate, and so forth.

Thus, for example, a formula could be used that provide more weight to users with very high sharing rates (e.g., 10-100 shares or more per day). In some embodiments, the formula may include a term for 1/sqrt(R). In some embodiments, the formula may include a term that averages the logarithm of the user's share rate. Depending on the formula chosen, emphasis may be given to different parts of the distribution of user share rates (e.g., more or less weight to users that are moderately active sharers, more or less weight to users with very high sharing rates, and so forth).

In some embodiments, different formulas may be applied to different types of users. For example, users may be classified into different buckets or types based on their share rate (e.g., users that share very little, users that are moderately active, users with very high sharing rates). Different types of users may be scored differently, such as by having users that are moderately active scored with a different formula than the users with very high sharing rates.

In some embodiments, the formula may be based on an evaluation of the typical quality of content items shared by the user (e.g., the process depicted in FIG. 6 is used re-iteratively to evaluate the user engagement scores). For example, the quality (e.g., based on the content quality score) of all the content shared by the user can be averaged. Or alternatively, the formula may consider the percentage of content shared by the user that has been classified under an undesirable category (e.g., by a machine learning model).

At block 506, the system may determine the user engagement score for the user based on the selected formula. The system may query all of a user's sharing activity over the time period associated with the selected formula in order to determine the user's daily share rate. For instance, in the previous example for which a user's score is 1/[1+log 2(1+R)], where R is the user's daily share rate (e.g., new shares and re-shares) over the past 8 days, the system may query the user's sharing activity from the past 8 days. The system may count the number of shares for the user in the past 8 days in order to determine the user's daily share rate over the past 8 days, which can then be used to calculate the user's score.

At block 508, the system may store the calculated user engagement score for the user. In some cases, historical user engagement scores for the user may already exist. In some embodiments, the system may additionally store the user' newly-determined user engagement score, such that the user's engagement score at various points in time is tracked.

In some embodiments, block 502 (e.g., tracking each user's sharing activity) may be an on-going process, while blocks 504, 506, and 508 may be performed for each user at pre-defined intervals. For instance, each user's engagement score may be calculated and updated on a daily basis (e.g., once a day), a weekly basis, every 8 days, and so forth. In some embodiments, each user's engagement score may be updated on-the-fly every time the user shares a new content item. Thus, in some embodiments, the system may track a user's score at points in time for which the user shared a content item.

In some embodiments, a user's engagement score may be referred may be aimed at quantifying a user's likelihood to engage in content. More things may be tracked beyond a user's sharing, such that a user's engagement score can be based off additional factors such as how much that user commented on the social network, how much time the user spent reading content shared with them (e.g. this user barely looks at the content that they are re-sharing), and any other type of engagement such as clicking, liking other user's shared content, commenting, etc. The user's engagement behavior may shift over time, and certain events or content topics may cause trigger a user to engage in more frequent engagement (e.g., increased sharing of content items).

FIG. 6 illustrates a flowchart 600 depicting a process for calculating a content quality score associated with a particular content item that has been shared by users of the social network. Examples of shareable content items include websites and webpages (e.g. an online article), image files (e.g., photos), audio files, video files, and so forth.

At block 602, the system may determine all the users of the social network that have shared that particular content item. In some embodiments, a record or log may be created whenever a user shares a content item which indicates the user (e.g., through a user ID unique to that user) and the content item (e.g., through a content ID that is associated with all instances of that particular content item). In some embodiments, the record or log may also indicate the user's engagement score (e.g., as described in regards to FIG. 5) at the time the user shared the content item. Thus, from the records or logs, the system may be able to identify all the instances that a particular content item was shared (e.g., by matching on the content ID) and all of the users that have shared that content item.

At block 604, the system may determine the user engagement score for all the users that have shared that content item. In some embodiments, the system may determine the current user engagement score associated with each of the users that have shared the content item by recalculating each user's engagement score.

In other embodiments, as previously mentioned, each user's engagement score at the time that user shared the content item may be available and the system may determine the user engagement score for the users at the time they shared the content item. This may be important because a user's engagement score may be based on a user's sharing tendencies over a period of time (e.g., a pre-defined time window) and the user's sharing tendencies may change. For instance, a user may generally have been someone who shares content infrequently (e.g., one share a week). However, one day that user may have discovered certain interests that the user is passionate about, resulting in the user becoming an avid sharer of content (e.g., the user begins sharing hundreds of times a week). Thus, in this example, the user's sharing tendencies have changed and any content being shared by the user after this change in the user's sharing tendencies should be evaluated based on the user's increased sharing frequency. For this reason, the system may be more concerned with a user's engagement score at the moment in time the user shares a particular content item rather than the user's current user engagement score (which may change over time).

Additionally, using each user's engagement score at the time they shared the particular content item, instead of each user's current user engagement score, to evaluate the quality of the content item is a technical improvement that allows for less resource utilization. A user's current user engagement score is dynamic and changes based on how often that user has shared over a pre-defined time window. If a particular content item's content quality score were to be based on the current user engagement score of every user that shared that content item, the current user engagement score of each of those users would have to be re-computed on-the-fly due to the dynamic nature of each user's engagement score. Thus, the amount of computational resources needed to evaluate the quality of a particular content item would increase exponentially as new users post that content item and the user engagement score of each user is continually recalculated and updated. In contrast, by evaluating content item quality using each user's engagement score at the time they shared the particular content item, as new users share the content item only the shares from the new users need to be calculated and incrementally factored into the evaluation of the content item quality.

At block 606, the system may optionally determine the content quality score formula to apply to evaluate the content item. This step may be optional because, in some embodiments, the same formula may be applied to all the content items. In other embodiments, different formulas may be used for different content items. In some of such embodiments, the formula used may be dynamically selected based on the characteristics of the content item being evaluated.

For example, in some embodiments, the formula may be selected based on the suspected quality of the content item being evaluated. For instance, if the content item is suspected to be of low quality (e.g., it was classified as such by a different algorithm, such as a probability model, classifier, or similar machine learning model), then the formula selected may apply a greater weighting towards the segment of users that shares more frequently (e.g., users with high average sharing tendency). Alternatively, if the content item is suspected to be of high quality, then the formula selected may give the sharing tendencies of the segment of users that shares more frequently less impact in the evaluation of the content item.

In some embodiments, there may be different formulas used for different content types (e.g., websites or webpages, images, video, and so forth). For instance, it may be the case that users tend to share images and photos more freely than links to webpages or articles, since the links may require more reading. Thus, the formula used for content items that are images and photos may factor in the likelihood of increased sharing (e.g., by downplaying the increased sharing) in order to evaluate the content quality.

In some embodiments, formula used may give different weight to the scores of different types of users. For example, in evaluating that particular content item, the user engagement scores of users that shared the content item may be weighted differently depending on how frequently each user shares. For a user that shares very frequently (e.g., 10-100 or more shares per day), their user engagement score might get weighted more or less than a user who shares very little.

At block 608, the system may determine the content quality score for the content item based on the formula selected. This determination may be made based on the user engagement scores for all the users that shared the content item. The score of various segments of those users may be weighted more or less depending on the formula used.

At block 610, the system may perform action based on the determined content quality score for that content item. In some embodiments, the system may change the rank of the content item based on its content quality score in order to affect the visibility of the content item on the social network to users (e.g., change the order the content item is displayed in each user's feed). In some embodiments, instead of altering the visibility of the content on the social network to all users, the system may only alter the visibility for some users. For example, instead of de-ranking a particular content item to make it appear lower in the feeds for all users, the system may allow that content item to have continued visibility for users that have expressed an interest in viewing that kind of content item. In other words, even if the content item is evaluated to be of low quality, it can still continue to be shared and displayed to users that have expressed interest in viewing similar content items of low quality.

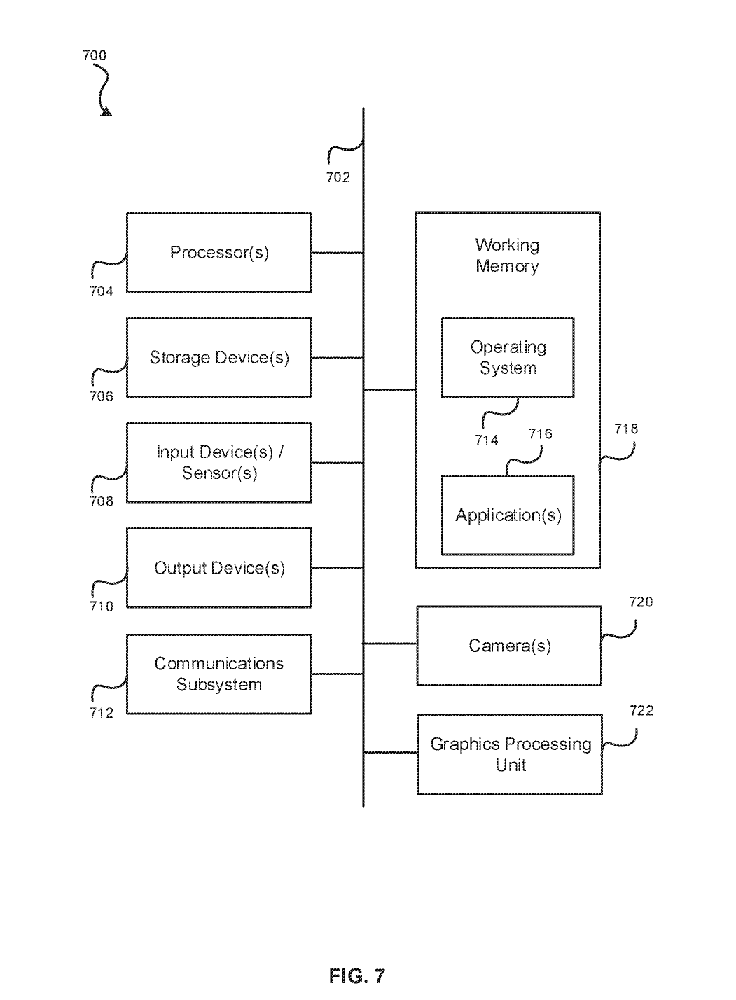

FIG. 7 illustrates an example of a computing system in which one or more embodiments may be implemented. A computer system as illustrated in FIG. 7 may be incorporated as part of the above described computerized device. For example, computer system 700 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 7 provides a schematic illustration of one embodiment of a computer system 700 that can perform the methods provided by various other embodiments, as described herein, and/or can function as the host computer system, a remote kiosk/terminal, a point- of-sale device, a telephonic or navigation or multimedia interface in an automobile, a computing device, a set-top box, a table computer and/or a computer system. FIG. 7 is meant only to provide a generalized illustration of various components, any or all of which may be utilized as appropriate. FIG. 7, therefore, broadly illustrates how individual system elements may be implemented in a relatively separated or relatively more integrated manner. In some embodiments, elements computer system 700 may be used to implement functionality of any of computer devices 112a-112d of FIG. 1.

The computer system 700 is shown comprising hardware elements that can be electrically coupled via a bus 702 (or may otherwise be in communication, as appropriate). The hardware elements may include one or more processors 704, including without limitation one or more general-purpose processors and/or one or more special- purpose processors (such as digital signal processing chips, graphics acceleration processors, and/or the like); one or more input devices 708, which can include without limitation one or more cameras, sensors, a mouse, a keyboard, a microphone configured to detect ultrasound or other sounds, and/or the like; and one or more output devices 710, which can include without limitation a display unit such as the device used in embodiments of the invention, a printer and/or the like.

In some implementations of the embodiments of the invention, various input devices 708 and output devices 710 may be embedded into interfaces such as display devices, tables, floors, walls, and window screens. Furthermore, input devices 708 and output devices 710 coupled to the processors may form multi-dimensional tracking systems.

The computer system 700 may further include (and/or be in communication with) one or more non-transitory storage devices 706, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 712, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or the like. The communications subsystem 712 may permit data to be exchanged with a network, other computer systems, and/or any other devices described herein. In many embodiments, the computer system 700 will further comprise a non-transitory working memory 718, which can include a RAM or ROM device, as described above.

The computer system 700 also can comprise software elements, shown as being currently located within the working memory 718, including an operating system 714, device drivers, executable libraries, and/or other code, such as one or more application programs 716, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 706 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 700 may be omitted or may be implemented separate from the illustrated system. For example, the processor 704 and/or other elements may be implemented separate from the input device 708. In one embodiment, the processor is configured to receive images from one or more cameras that are separately implemented. In some embodiments, elements in addition to those illustrated in FIG. 7 may be included in the computer system 700.

Some embodiments may employ a computer system (such as the computer system 700) to perform methods in accordance with the disclosure. For example, some or all of the procedures of the described methods may be performed by the computer system 700 in response to processor 704 executing one or more sequences of one or more instructions (which might be incorporated into the operating system 714 and/or other code, such as an application program 716) contained in the working memory 718. Such instructions may be read into the working memory 718 from another computer-readable medium, such as one or more of the storage device(s) 706. Merely by way of example, execution of the sequences of instructions contained in the working memory 718 might cause the processor(s) 904 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 700, various computer-readable media might be involved in providing instructions/code to processor(s) 704 for execution and/or might be used to store and/or carry such instructions/code (e.g., as signals). In many implementations, a computer- readable medium is a physical and/or tangible storage medium. Such a medium may take many forms, including but not limited to, non-volatile media, volatile media, and transmission media. Non-volatile media include, for example, optical and/or magnetic disks, such as the storage device(s) 706. Volatile media include, without limitation, dynamic memory, such as the working memory 718. Transmission media include, without limitation, coaxial cables, copper wire and fiber optics, including the wires that comprise the bus 702, as well as the various components of the communications subsystem 712 (and/or the media by which the communications subsystem 712 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 704 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 712 (and/or components thereof) generally will receive the signals, and the bus 702 then might carry the signals (and/or the data, instructions, etc. carried by the signals) to the working memory 718, from which the processor(s) 704 retrieves and executes the instructions. The instructions received by the working memory 718 may optionally be stored on a non-transitory storage device 706 either before or after execution by the processor(s) 704.

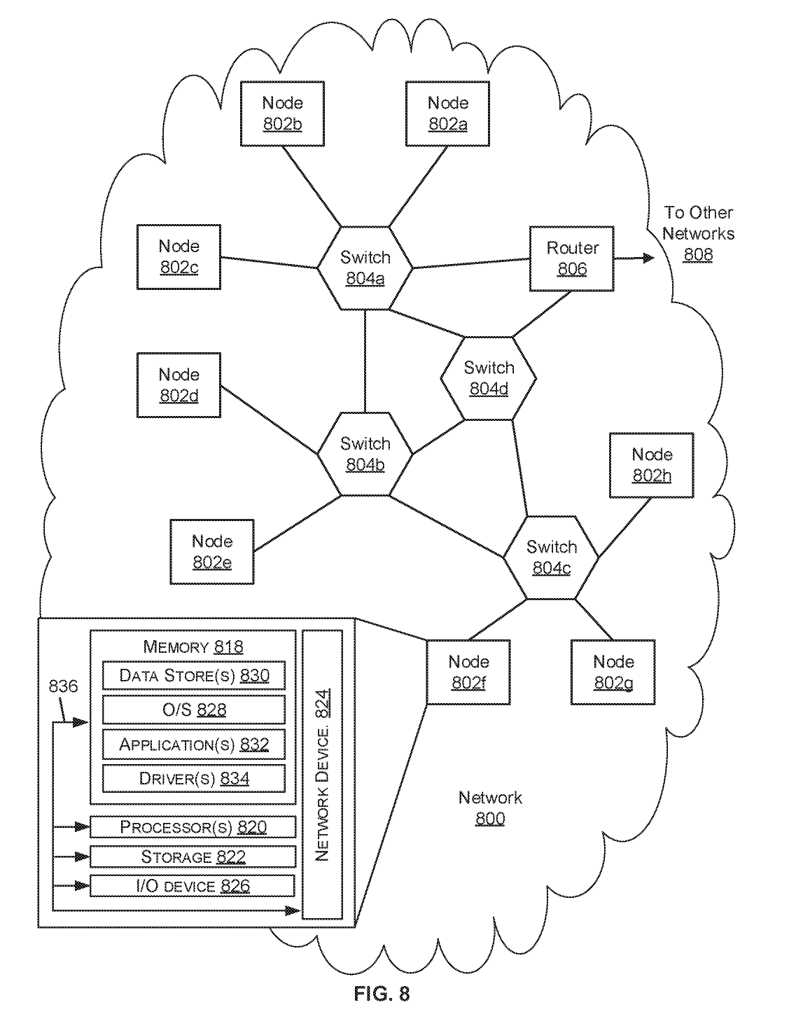

FIG. 8 illustrates a network 800, illustrating various different types of computer devices of FIG. 7, such as nodes comprising the computer device, switches and routers. In certain embodiments, the network 800 may be based on a switched architecture with point-to-point links. Network 800 can be used to implement social network infrastructure 80. As illustrated in FIG. 8, the network 800 can include a plurality of switches 804a-804d, which may be arranged in a network. In some cases, the switches are arranged in a multi-layered network, such as a Clos network. A device that filters and forwards packets between local area network (LAN) segments may be referred to as a switch. Switches generally operate at the data link layer (layer 2) and sometimes the network layer (layer 3) of the Open System Interconnect (OSI) Reference Model and may support several packet protocols. Switches 804a-804d may be connected to a plurality of nodes 802a-802h and provide multiple paths between any two nodes.

The network 800 may also include one or more devices for connection with other networks 808, such as other subnets, LANs, wide area networks (WANs), or the Internet, and may be referred to as routers 806. Routers can use headers and forwarding tables to determine the best path for forwarding the packets, and use protocols such as internet control message protocol (ICMP) to communicate with each other and configure the best route between any two devices.

In some examples, network(s) 800 may include any one or a combination of many different types of networks, such as cable networks, wireless networks, cellular networks and other private and/or public networks. Interconnected switches 804a-804d and router 806, if present, may be referred to as a switch fabric, a fabric, a network fabric, or simply a network. In the context of a computer network, terms “fabric” and “network” may be used interchangeably herein.

Nodes 802a-802h may be any combination of host systems, processor nodes, storage subsystems, and I/O chassis that represent user devices, service provider computers or third party computers.

User devices may include computing devices to access an application 832 (e.g., a web browser or mobile device application). In some aspects, the application 832 may be hosted, managed, and/or provided by a computing resources service or service provider. The application 832 may allow the user(s) to interact with the service provider computer(s) to, for example, access web content (e.g., web pages, music, video, etc.). The user device(s) may be a computing device such as for example a mobile phone, a smart phone, a personal digital assistant (PDA), a laptop computer, a netbook computer, a desktop computer, a thin-client device, a tablet computer, an electronic book (e-book) reader, a gaming console, etc. In some examples, the user device(s) may be in communication with the service provider computer(s) via the other network(s) 808. Additionally, the user device(s) may be part of the distributed system managed by, controlled by, or otherwise part of the service provider computer(s) (e.g., a console device integrated with the service provider computers).

The node(s) of FIG. 8 may also represent one or more service provider computers. One or more service provider computers may provide a native application that is configured to run on the user devices, which user(s) may interact with. The service provider computer(s) may, in some examples, provide computing resources such as, but not limited to, client entities, low latency data storage, durable data storage, data access, management, virtualization, cloud-based software solutions, electronic content performance management, and so on. The service provider computer(s) may also be operable to provide web hosting, databasing, computer application development and/or implementation platforms, combinations of the foregoing or the like to the user(s). In some embodiments, the service provider computer(s) may be provided as one or more virtual machines implemented in a hosted computing environment. The hosted computing environment may include one or more rapidly provisioned and released computing resources. These computing resources may include computing, networking and/or storage devices. A hosted computing environment may also be referred to as a cloud computing environment. The service provider computer(s) may include one or more servers, perhaps arranged in a cluster, as a server farm, or as individual servers not associated with one another and may host the application 832 and/or cloud-based software services. These servers may be configured as part of an integrated, distributed computing environment. In some aspects, the service provider computer(s) may, additionally or alternatively, include computing devices such as for example a mobile phone, a smart phone, a personal digital assistant (PDA), a laptop computer, a desktop computer, a netbook computer, a server computer, a thin-client device, a tablet computer, a gaming console, etc. In some instances, the service provider computer(s), may communicate with one or more third party computers.

In one example configuration, the node(s) 802a-802h may include at least one memory 818 and one or more processing units (or processor(s) 820). The processor(s) 820 may be implemented in hardware, computer-executable instructions, firmware, or combinations thereof. Computer-executable instruction or firmware implementations of the processor(s) 820 may include computer-executable or machine-executable instructions written in any suitable programming language to perform the various functions described.

In some instances, the hardware processor(s) 820 may be a single core processor or a multi-core processor. A multi-core processor may include multiple processing units within the same processor. In some embodiments, the multi-core processors may share certain resources, such as buses and second or third level caches. In some instances, each core in a single or multi-core processor may also include multiple executing logical processors (or executing threads). In such a core (e.g., those with multiple logical processors), several stages of the execution pipeline and also lower level caches may also be shared.

The memory 818 may store program instructions that are loadable and executable on the processor(s) 820, as well as data generated during the execution of these programs. Depending on the configuration and type of the node(s) 802a-802h, the memory 818 may be volatile (such as RAM) and/or non-volatile (such as ROM, flash memory, etc.). The memory 818 may include an operating system 828, one or more data stores 830, one or more application programs 832, one or more drivers 834, and/or services for implementing the features disclosed herein.

The operating system 828 may support nodes 802a-802h basic functions, such as scheduling tasks, executing applications, and/or controller peripheral devices. In some implementations, a service provider computer may host one or more virtual machines. In these implementations, each virtual machine may be configured to execute its own operating system. Examples of operating systems include Unix, Linux, Windows, Mac OS, iOS, Android, and the like. The operating system 828 may also be a proprietary operating system.

The data stores 830 may include permanent or transitory data used and/or operated on by the operating system 828, application programs 832, or drivers 834. Examples of such data include web pages, video data, audio data, images, user data, and so on. The information in the data stores 830 may, in some implementations, be provided over the network(s) 808 to user devices 804. In some cases, the data stores 830 may additionally or alternatively include stored application programs and/or drivers. Alternatively or additionally, the data stores 830 may store standard and/or proprietary software libraries, and/or standard and/or proprietary application user interface (API) libraries. Information stored in the data stores 830 may be machine-readable object code, source code, interpreted code, or intermediate code.

The drivers 834 include programs that may provide communication between components in a node. For example, some drivers 834 may provide communication between the operating system 828 and additional storage 822, network device 824, and/or I/O device 826. Alternatively or additionally, some drivers 834 may provide communication between application programs 832 and the operating system 828, and/or application programs 832 and peripheral devices accessible to the service provider computer. In many cases, the drivers 834 may include drivers that provide well-understood functionality (e.g., printer drivers, display drivers, hard disk drivers, Solid State Device drivers). In other cases, the drivers 834 may provide proprietary or specialized functionality.

The service provider computer(s) or servers may also include additional storage 822, which may include removable storage and/or non-removable storage. The additional storage 822 may include magnetic storage, optical disks, solid state disks, flash memory, and/or tape storage. The additional storage 822 may be housed in the same chassis as the node(s) 802a-802h or may be in an external enclosure. The memory 818 and/or additional storage 822 and their associated computer-readable media may provide non-volatile storage of computer-readable instructions, data structures, program modules, and other data for the computing devices. In some implementations, the memory 818 may include multiple different types of memory, such as SRAM, DRAM, or ROM.

The memory 818 and the additional storage 822, both removable and non-removable, are examples of computer-readable storage media. For example, computer-readable storage media may include volatile or non-volatile, removable or non-removable media implemented in a method or technology for storage of information, the information including, for example, computer-readable instructions, data structures, program modules, or other data. The memory 818 and the additional storage 822 are examples of computer storage media. Additional types of computer storage media that may be present in the node(s) 802a-802h may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, solid state drives, or some other medium which can be used to store the desired information and which can be accessed by the node(s) 802a-802h . Computer-readable media also includes combinations of any of the above media types, including multiple units of one media type.

Alternatively or additionally, computer-readable communication media may include computer-readable instructions, program modules or other data transmitted within a data signal, such as a carrier wave or other transmission. However, as used herein, computer-readable storage media does not include computer-readable communication media.

The node(s) 802a-802h may also include I/O device(s) 826, such as a keyboard, a mouse, a pen, a voice input device, a touch input device, a display, speakers, a printer, and the like. The node(s) 802a-802h may also include one or more communication channels 836. A communication channel 836 may provide a medium over which the various components of the node(s) 802a-802h can communicate. The communication channel or channels 836 may take the form of a bus, a ring, a switching fabric, or a network.

The node(s) 802a-802h may also contain network device(s) 826 that allow the node(s) 802a-802h to communicate with a stored database, another computing device or server, user terminals and/or other devices on the network(s) 800. Each of node(s) 802a-802h of FIG. 8 may include similar components and/or functionality discussed with regarding to computer system 700 of FIG. 7.

In some implementations, the network device 826 is a peripheral device, such as a PCI-based device. In these implementations, the network device 826 includes a PCI interface for communicating with a host device. The term “PCI” or “PCI-based” may be used to describe any protocol in the PCI family of bus protocols, including the original PCI standard, PCI-X, Accelerated Graphics Port (AGP), and PCI-Express(PCIe) or any other improvement or derived protocols that are based on the PCI protocols discussed herein. The PCI-based protocols are standard bus protocols for connecting devices, such as a local peripheral device to a host device. A standard bus protocol is a data transfer protocol for which a specification has been defined and adopted by various manufacturers. Manufacturers ensure that compliant devices are compatible with computing systems implementing the bus protocol, and vice versa. As used herein, PCI-based devices also include devices that communicate using Non-Volatile Memory Express (NVMe). NVMe is a device interface specification for accessing non-volatile storage media attached to a computing system using PCIe. For example, the bus interface module 808 may implement NVMe, and the network device 826 may be connected to a computing system using a PCIe interface.

A PCI-based device may include one or more functions. A “function” describes operations that may be provided by the network device 826. Examples of functions include mass storage controllers, network controllers, display controllers, memory controllers, serial bus controllers, wireless controllers, and encryption and decryption controllers, among others. In some cases, a PCI-based device may include more than one function. For example, a PCI-based device may provide a mass storage controller and a network adapter. As another example, a PCI-based device may provide two storage controllers, to control two different storage resources. In some implementations, a PCI-based device may have up to eight functions.

In some implementations, the network device 826 may include single-root I/O virtualization (SR-IOV). SR-IOV is an extended capability that may be included in a PCI-based device. SR-IOV allows a physical resource (e.g., a single network interface controller) to appear as multiple resources (e.g., sixty-four network interface controllers). Thus, a PCI-based device providing a certain functionality (e.g., a network interface controller) may appear to a device making use of the PCI-based device to be multiple devices providing the same functionality. The functions of an SR-IOV-capable storage adapter device may be classified as physical functions (PFs) or virtual functions (VFs). Physical functions are fully featured functions of the device that can be discovered, managed, and manipulated. Physical functions have configuration resources that can be used to configure or control the storage adapter device. Physical functions include the same configuration address space and memory address space that a non-virtualized device would have. A physical function may have a number of virtual functions associated with it. Virtual functions are similar to physical functions, but are light-weight functions that may generally lack configuration resources, and are generally controlled by the configuration of their underlying physical functions. Each of the physical functions and/or virtual functions may be assigned to a respective thread of execution (such as for example, a virtual machine) running on a host device.

The modules described herein may be software modules, hardware modules or a suitable combination thereof. If the modules are software modules, the modules can be embodied on a non-transitory computer readable medium and processed by a processor in any of the computer systems described herein. It should be noted that the described processes and architectures can be performed either in real-time or in an asynchronous mode prior to any user interaction. The modules may be configured in the manner suggested in FIG. 7, FIG. 8, and/or functions described herein can be provided by one or more modules that exist as separate modules and/or module functions described herein can be spread over multiple modules.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Various embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 1204—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method, comprising:
identifying, by one or more internetworked computer devices implementing a social network, a set of engagement actions relating to each user of a first plurality of users on the social network, wherein the set of engagement actions relating to each user of the first plurality of users is associated with the respective user engaging content items on the social network;
determining, by the one or more internetworked computer devices, a user engagement score for each user of the first plurality of users based on the set of engagement actions relating to the respective user;
identifying, by the one or more internetworked computer devices, a second plurality of users on the social network that has engaged a content item on the social network, wherein the second plurality of users is a subset of the first plurality of users;
retrieving, by the one or more internetworked computer devices, the user engagement score for each user of the second plurality of users;
determining, by the one or more internetworked computer devices, a content quality score for the content item based on the retrieved user engagement score for each user of the second plurality of users; and
based at least in part on the content quality score, performing, by the one or more internetwork computer devices, an action for changing visibility of the content item within the social network.

2. The method of claim 1, wherein the set of engagement actions relating to each user of the first plurality of users includes new shares or re-shares by the respective user of the first plurality of users.

3. The method of claim 1, wherein the set of engagement actions relating to each user of the first plurality of users includes new shares or re-shares over an eight day time period by the respective user of the first plurality of users.

4. The method of claim 1, wherein the method further comprises:
determining, by the one or more internetworked computer devices, a user engagement score formula,
and wherein determining a user engagement score for each user of the first plurality of users is further based on the user engagement score formula.

5. The method of claim 1, wherein the method further comprises:
determining, by the one or more internetworked computer devices, a content quality score formula,
and wherein determining a content quality score for the content item is further based on the content quality score formula.

6. The method of claim 1, wherein the content item is a website, webpage, image, or video clip.

7. The method of claim 1, wherein the set of engagement actions relating to each user of the first plurality of users includes likes, comments, or clicks initiated by the respective user of the first plurality of users.

8. The method of claim 4, wherein the user engagement score formula is 1/[1+log 2(1+R)], and wherein R is a ratio of new shares or re-shares per day over an eight day time period by the respective user of the first plurality of users.

9. The method of claim 1, wherein the one or more internetworked computer devices are configured to store a plurality of records for each user of the first plurality of users, wherein the plurality of records for the respective user includes the set of engagement actions relating to the respective user, and wherein each record of the of the plurality of records for the respective user logs an engagement action with associated with the content item.

10. The method of claim 1, wherein the content quality score is indicative of low quality, and wherein performing the action for changing visibility of the content item within the social network includes removing the content item from a user feed.

11. The method of claim 1, wherein the content quality score is indicative of low quality, and wherein performing the action for changing visibility of the content item within the social network includes preventing the content item from appearing in a user feed.

12. The method of claim 1, wherein the user engagement score for each user of the first plurality of users is a value between zero and one.

13. The method of claim 1, wherein the content quality score for the content item is an average of the retrieved user engagement score for each user of the second plurality of users.

14. A computer system, comprising:
one or more internetworked computer devices, the one or more internetworked computer devices implementing a social network, wherein the one or more internetworked computer devices are configured to:
identify a set of engagement actions relating to each user of a first plurality of users on the social network, wherein the set of engagement actions relating to each user of the first plurality of users is associated with the respective user engaging content items on the social network;
determine a user engagement score for each user of the first plurality of users based on the set of engagement actions relating to the respective user;
identify a second plurality of users on the social network that has engaged a content item on the social network, wherein the second plurality of users is a subset of the first plurality of users;
retrieve the user engagement score for each user of the second plurality of users;
determine a content quality score for the content item based on the retrieved user engagement score for each user of the second plurality of users; and
based at least in part on the content quality score, perform an action for changing visibility of the content item within the social network.

15. The computer system of claim 14, wherein the set of engagement actions relating to each user of the first plurality of users includes new shares or re-shares by the respective user of the first plurality of users.

16. The computer system of claim 14, wherein the set of engagement actions relating to each user of the first plurality of users includes new shares or re-shares over an eight day time period by the respective user of the first plurality of users.

17. The computer system of claim 14, wherein the one or more internetworked computer devices are further configured to:
determine a user engagement score formula,
and wherein determining a user engagement score for each user of the first plurality of users is further based on the user engagement score formula.

18. The computer system of claim 14, wherein the one or more internetworked computer devices are further configured to:
determine a content quality score formula,
and wherein determining a content quality score for the content item is further based on the content quality score formula.

19. The computer system of claim 14, wherein the content item is a website, webpage, image, or video clip.

20. One or more non-transitory computer-readable media storing computer-executable instructions that, when executed, cause one or more internetworked computer devices to:
identify a set of engagement actions relating to each user of a first plurality of users on a social network, wherein the one or more internetworked computer devices implement the social network, and wherein the set of engagement actions relating to each user of the first plurality of users is associated with the respective user engaging content items on the social network;
determine a user engagement score for each user of the first plurality of users based on the set of engagement actions relating to the respective user;
identify a second plurality of users on the social network that has engaged a content item on the social network, wherein the second plurality of users is a subset of the first plurality of users;
retrieve the user engagement score for each user of the second plurality of users;
determine a content quality score for the content item based on the retrieved user engagement score for each user of the second plurality of users; and
based at least in part on the content quality score, perform an action for changing visibility of the content item within the social network.
